(19) United States
(12) Patent Application Publication
(10) Pub. No.: US 2026/0296034 A1
(43) Pub. Date: Oct. 1, 2026

(54) LIQUID CONTAINER AND LIQUID REPLENISHMENT SYSTEM

(71) Applicant: CANON KABUSHIKI KAISHA, Tokyo (JP)

(72) Inventors: HIROAKI KUSANO, Tokyo (JP); JUNICHIRO IRI, Kanagawa (JP)

(21) Appl. No.: 19/570,293

(22) Filed: Mar. 18, 2026

(30) Foreign Application Priority Data
Mar. 27, 2025 (JP) 2025-054448

(51) Int. Cl. B41J 2/175

(52) U.S. Cl. CPC B41J 2/175

(57) ABSTRACT

An object of the present disclosure is to provide a liquid container capable of further simplifying a configuration of opening and closing a flow passage portion. In turn, an object of the present disclosure is to provide technologies which have the potential to contribute to achievement of a sustainable society such as a decarbonized society/circular society. The liquid container includes: a containing portion configured to contain an ink; and a flow passage portion provided to the containing portion and configured to supply the ink from inside the containing portion to outside. The flow passage portion has flexibility. The flow passage portion is closed by being deformed.

### BACKGROUND

### Field of the Technology

The technologies described in this specification have the potential to contribute to the achievement of a sustainable society, such as a decarbonized society/circular society.

Specifically, the present disclosure relates to a liquid container and a liquid replenishment system. Specifically, the present disclosure relates to a liquid container including: a containing portion configured to contain a liquid inside; and a flow passage portion configured to discharge the liquid from inside the containing portion to outside.

### Description of the Related Art

As a liquid container of this type, Japanese Patent Laid-Open No. 2017-113891 discloses a liquid container including: a liquid containing portion configured to contain an ink; and a flow passage portion including a supply port at an end portion, and being configured to supply the ink contained inside the liquid containing portion to outside.

According to the liquid container of Japanese Patent Laid-Open No. 2017-113891, it becomes possible to supply the ink contained inside the liquid containing portion to outside via the flow passage portion.

However, in the liquid container of Japanese Patent Laid-Open No. 2017-113891, a supply needle of a liquid consuming apparatus (liquid ejection apparatus) is inserted into the flow passage portion of the liquid container to supply the ink from the flow passage portion to the supply needle. For this reason, in the liquid container of Japanese Patent Laid-Open No. 2017-113891, a configuration for opening and closing the flow passage portion becomes relatively complicated.

In addition, recently, in order to achieve a sustainable society, in the case of manufacturing a liquid container as a product, it has been demanded to reduce the amount of plastics to be used as the materials of the liquid container. Under such circumstances, it is desirable to further simplify the configuration for opening and closing a flow passage portion of a liquid container.

### SUMMARY

The present disclosure is to provide a liquid container capable of further simplifying a configuration for opening and closing a flow passage portion

A liquid container of the present disclosure includes: a containing portion configured to contain an ink; and a flow passage portion provided to the containing portion and configured to supply the ink from inside the containing portion to outside, wherein the flow passage portion has flexibility, and is closed by being deformed.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram of an ink pack in an embodiment;

FIG. 2A is a diagram showing an ink replenishment method in an embodiment;

FIG. 2B is a diagram showing the ink replenishment method in an embodiment;

FIG. 2C is a diagram showing the ink replenishment method in an embodiment;

FIG. 2D is a diagram showing the ink replenishment method in an embodiment;

FIG. 2E is a diagram showing the ink replenishment method in an embodiment;

FIG. 3 is a schematic diagram of an ink pack in an embodiment;

FIG. 4A is a diagram showing an ink replenishment method in an embodiment;

FIG. 4B is a diagram showing the ink replenishment method in an embodiment;

FIG. 4C is a diagram showing the ink replenishment method in an embodiment;

FIG. 5 is a schematic diagram of an ink pack in an embodiment;

FIG. 6A is a diagram showing an ink replenishment method in an embodiment;

FIG. 6B is a diagram showing the ink replenishment method in an embodiment;

FIG. 6C is a diagram showing the ink replenishment method in an embodiment;

FIG. 7 is a schematic diagram of an ink pack in an embodiment;

FIG. 8A is a diagram showing an ink replenishment method in an embodiment;

FIG. 8B is a diagram showing the ink replenishment method in an embodiment;

FIG. 8C is a diagram showing the ink replenishment method in an embodiment;

FIG. 9 is a schematic diagram of an ink pack in an embodiment;

FIG. 10A is a diagram showing an ink replenishment method in an embodiment;

FIG. 10B is a diagram showing the ink replenishment method in an embodiment;

FIG. 10C is a diagram showing the ink replenishment method in an embodiment;

FIG. 10D is a diagram showing the ink replenishment method in an embodiment;

FIG. 10E is a diagram showing the ink replenishment method in an embodiment; and

FIG. 10F is a diagram showing the ink replenishment method in an embodiment.

### DESCRIPTION OF THE EMBODIMENTS

### First Embodiment

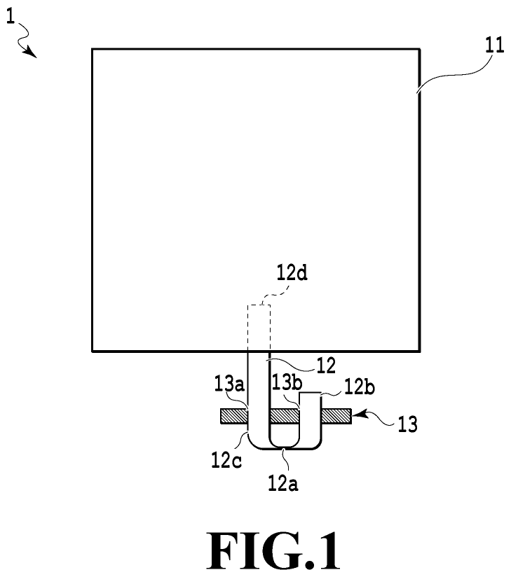

FIG. 1 is a schematic diagram of an ink pack 1 in a first embodiment.

The ink pack 1 (liquid container) shown in FIG. 1 is configured to be capable of containing an ink to be supplied to a liquid ejection apparatus (for example, an inkjet-type printer which is not shown) configured to eject a liquid.

As shown in FIG. 1, the ink pack 1 includes: a containing portion 11 configured to contain an ink; and a flow passage portion 12 provided to the containing portion 11 and configured to supply the ink from inside the containing portion 11 to outside.

The flow passage portion 12 of the present embodiment is formed of a relatively soft material, and has flexibility. The flow passage portion 12 is configured such that the flow passage portion 12 can be closed by bending the flow passage portion 12 itself, and is configured such that the flow passage portion 12 can be opened by releasing the bending.

Specifically, by bending the flow passage portion 12 by 180 degrees, a bent portion 12a in which inner surfaces are in close contact with each other is formed. According to this configuration, the ink is blocked inside the bent portion 12a. This allows the flow passage portion 12 to be closed. As a result, the leakage of the ink contained in the containing portion 11 from a front end portion 12b including an outlet of the flow passage portion 12 can be suppressed. For example, only by bending and tying the flow passage portion 12, the flow passage portion 12 can be closed.

The Shore A hardness of the material of the flow passage portion 12 of the present embodiment is 30 or less. An example of the material of the flow passage portion 12 which can make the Shore A hardness 30 or less includes silicone or urethane, or the like.

The shape of the flow passage portion 12 is a tube shape, and the thickness of the flow passage portion 12 is 0.5 mm or more and 2.0 mm or less. The inner diameter of the flow passage portion 12 is 3.0 mm or more and 8.0 mm or less. The outer diameter of the flow passage portion 12 is 4.0 mm or more and 12.0 mm or less.

It is desirable that a flow passage holding portion 13 for holding the flow passage portion 12 be detachably attached on an outer side of the flow passage portion 12. This is because by providing the flow passage holding portion 13, the state where the flow passage portion 12 is bent can be easily maintained.

The flow passage holding portion 13 includes a first hole 13a and a second hole 13b through which the flow passage portion 12 can be passed. Through the first hole 13a, the flow passage portion 12 let out from a connection portion with the containing portion 11 is passed. This state where the front end portion 12b is passed only through the first hole 13a corresponds to an open state of the flow passage portion 12. On the other hand, the state where the front end portion 12b is passed through the first hole 13a and the second hole 13b, which is shown in FIG. 1, corresponds to a closed state of the flow passage portion 12.

For example, to close the flow passage portion 12, the user holds the front end portion 12b of the flow passage portion 12 which has been passed through the first hole 13a, passes the front end portion 12b through the second hole 13b, and bends the flow passage portion 12 by 180 degrees to form the above-mentioned bent portion 12a. By forming the bent portion 12a and engaging the front end portion 12b with the second hole 13b in this way, the state where the flow passage portion 12 has been bent can be maintained.

An example of the material of the flow passage holding portion 13 in the present embodiment includes hard rubber or the like. The flow passage holding portion 13 may be formed of plastic. However, in the case where the flow passage holding portion 13 is formed of hard rubber, the amount of plastic to be used in manufacturing the ink pack 1 can be reduced as compared with the case where the flow passage holding portion 13 is formed of plastic. That is, forming the flow passage holding portion 13 of rubber can contribute to achievement of a decarbonized sustainable society.

The outer diameter of the front end portion 12b of the flow passage portion 12 is slightly smaller than the inner diameter of the second hole 13b of the flow passage holding portion 13. According to this configuration, the front end portion 12b of the flow passage portion 12 can be passed through the second hole 13b of the flow passage holding portion 13 to be held.

That is, the front end portion 12b of the flow passage portion 12 is not fixed to the second hole 13b of the flow passage holding portion 13. Then, a middle portion 12c of the flow passage portion 12 is also not fixed to the first hole 13a. According to this configuration, by applying an external force to the flow passage portion 12 in a direction in which the flow passage portion 12 extends (an up-down direction in FIG. 1), the front end portion 12b can be moved inside the second hole 13b along the direction in which the flow passage portion 12 extends. Moreover, the middle portion 12c can also be moved inside the first hole 13a along the direction in which the flow passage portion 12 extends.

For example, by pressing the flow passage portion 12 downward from above in the state where the flow passage holding portion 13 is held, the front end portion 12b of the flow passage portion 12 which is held in the second hole 13b of the flow passage holding portion 13 can be detached from the second hole 13b. Once the front end portion 12b is removed from the second hole 13b, the flow passage portion 12 returns to an original shape (straight shape) with an elastic restoring force.

After the flow passage portion 12 has returned to the original shape, by pulling out the middle portion 12c and the front end portion 12b of the flow passage portion 12 from the first hole 13a, the flow passage holding portion 13 can be detached from the flow passage portion 12, so that the flow passage holding portion 13 can be reused. The configuration in which the flow passage holding portion 13 is detachably attached to the flow passage portion 12 for reusing the flow passage holding portion 13 in this way can contribute to the achievement of a circular society.

In addition, since the flow passage holding portion 13 is provided on the outer side of the flow passage portion 12, the possibility that the ink flowing inside the flow passage portion 12 adheres to the flow passage holding portion 13 is very low. Hence, even in the case of reusing the flow passage holding portion 13, the flow passage holding portion 13 can be reused without washing. This eliminates the need to use a detergent and water for washing the flow passage holding portion 13. That is, providing the flow passage holding portion 13 to the flow passage portion 12 such that the flow passage holding portion 13 can be reused without washing can contribute to the achievement of a sustainable society.

In addition, the containing portion 11 is configured by forming a sheet having flexibility into a bag shape. For example, the containing portion 11 may be formed by pasting outer peripheral portions of two films having ink resistance to each other. Alternatively, the containing portion 11 may be formed by bending a single film having ink resistance, and pasting outer peripheral portions of the film to each other. By forming the containing portion 11 into a bag shape in this way, a space capable of containing the ink is formed inside the containing portion 11.

This space is formed by forming an opening without fixing part of the outer periphery of the containing portion 11 shaped in a bag shape, and inserting, from the opening, a base end portion 12d including an inlet of the flow passage portion 12 into the containing portion 11, and liquid-tightly fixing (for example, thermally welding) the opening.

Note that side surfaces may be provided, or do not have to be provided, on the left and right sides of the containing portion 11. In the case where side surfaces are provided on the left and right sides of the containing portion 11, a gusset may be formed, or does not have to be formed, in each of the side surfaces. That is, a so-called, pillow-type containing portion 11 in which no gussets are formed in the side surfaces may be formed, or a so-called gusset-type containing portion 11 in which gussets are formed in the side surfaces may be formed.

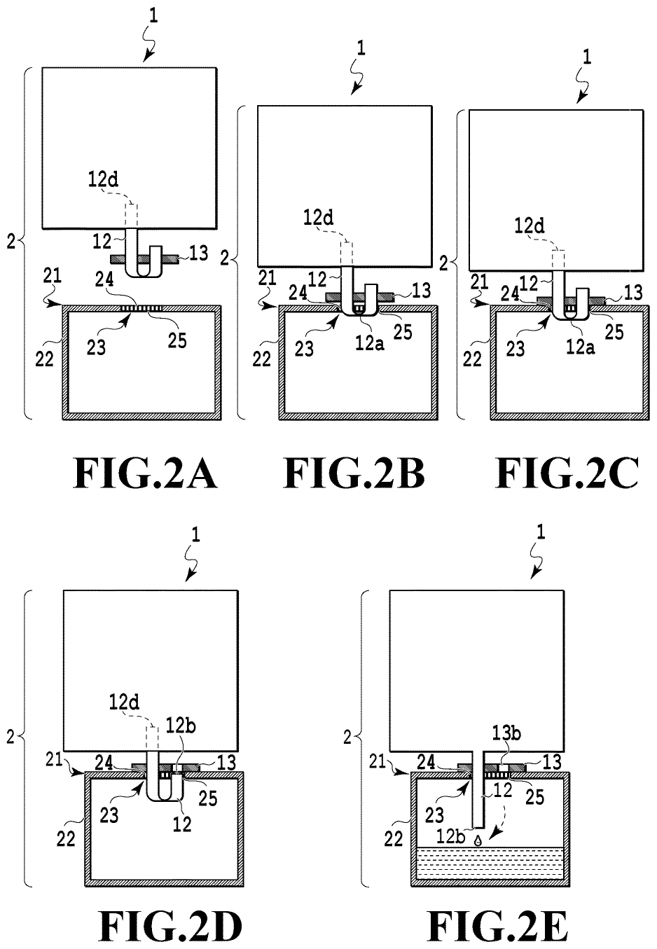

FIG. 2A to FIG. 2E are diagrams showing an ink replenishment method in the present embodiment.

As shown in FIG. 2A, a liquid replenishment system 2 of the present embodiment includes: the ink pack 1, which has been described by using FIG. 1; and an ink tank 21 configured to store the ink. The ink tank 21 is provided in a liquid ejection apparatus (not shown). That is, the ink pack 1 of the present embodiment is a container configured to replenish the ink tank 21 with the ink.

In a main body 22 of the ink tank 21, an opening portion 23 which is narrower than the width of the flow passage holding portion 13 of the ink pack 1 (a length in the left-right direction of FIG. 2), and also is larger than the outer diameter of the flow passage portion 12 of the ink pack 1 is formed. The opening portion 23 allows the inside of the main body 22 and the outside to communicate with each other.

In an inner surface of the opening portion 23, an absorption member 24 (for example, a sponge) capable of absorbing the ink is provided. In the absorption member 24 of the ink tank 21, an insertion slot 25 (for example, a slit, which is not shown) for inserting the flow passage portion 12 of the ink pack 1 is formed.

Note that it is desirable that the capacity of the ink tank 21 be larger than the capacity of the ink pack 1. According to this configuration, the ink tank 21 can be replenished with all the ink contained in the ink pack 1, although it depends on the remaining amount of the ink in the ink tank 21. According to this configuration, the ink contained in the ink pack 1 can be used up with one replenishment of the ink. Hence, the flow passage holding portion 13 can be detached from the used ink pack 1, and the flow passage holding portion 13 can be immediately recovered for reuse.

As shown in FIG. 2B, to connect the ink pack 1 to the ink tank 21, the bent portion 12a of the flow passage portion 12 is first inserted into the insertion slot 25 of the absorption member 24.

As shown in FIG. 2C, in the state where the bent portion 12a has been inserted in the insertion slot 25, bringing the ink pack 1 even closer to the ink tank 21 brings a lower surface of the flow passage holding portion 13 into contact with an upper surface of the main body 22.

As shown in FIG. 2D, in the state where the lower surface of the flow passage holding portion 13 has been brought into contact with the upper surface of the main body 22, bringing the ink pack 1 even closer to the ink tank 21 causes the flow passage portion 12 to be displaced relative to the flow passage holding portion 13, and move deeper into the main body 22.

As shown in FIG. 2E, bringing the ink pack 1 even closer to the ink tank 21 from the state shown in FIG. 2D causes the front end portion 12b of the flow passage portion 12 to be displaced relative to the second hole 13b of the flow passage holding portion 13, so that the front end portion 12b is removed from the second hole 13b. Once the front end portion 12b is removed from the second hole 13b, the bending of the flow passage portion 12 is lessened, so that the state where the bent portion 12a has closed the flow passage portion 12 is released. That is, once the front end portion 12b is removed from the second hole 13b, the flow passage portion 12 is opened, so that the ink tank 21 is replenished with the ink from the ink pack 1.

After the replenishment of the ink ends, moving the ink pack 1 away from the ink tank 21 releases the connection between the ink pack 1 and the ink tank 21.

At the time of pulling out the flow passage portion 12 from the opening portion 23, the front end portion 12b of the flow passage portion 12 slides on the insertion slot 25 of the absorption member 24. This causes the ink which has adhered to the front end portion 12b of the flow passage portion 12 to be wiped off and absorbed by the absorption member 24. That is, after the connection between the ink pack 1 and the ink tank 21 is released, the scattering of the ink which has adhered to the front end portion 12b of the flow passage portion 12 to smear the periphery of the ink tank 21 is suppressed. According to this configuration, the leakage of the ink from the flow passage portion 12 can be suppressed even after the ink pack 1 is moved away from the ink tank 21.

As described above, in the ink pack 1 of the present embodiment, the flow passage portion 12 can be closed only by bending the flow passage portion 12, and the flow passage portion 12 can be opened only by lessening the bending of the flow passage portion 12. Hence, there is no need to provide a configuration dedicated to opening and closing the flow passage portion 12, and the number of members required for manufacturing the ink pack 1 can be reduced. Note that even in the case of using the flow passage holding portion 13 for closing the flow passage portion 12, only one member is required for opening and closing the flow passage portion 12. That is, manufacturing the flow passage portion 12 using a material having flexibility can contribute to the achievement of a sustainable society.

Therefore, according to the ink pack 1 of the present embodiment, the configuration for opening and closing the flow passage portion 12 can be further simplified.

### Second Embodiment

In the following description, the same or corresponding configurations as or to those of the ink pack 1 in the first embodiment will be denoted by the same signs and the description thereof will be omitted, and different points will be mainly described.

An object of an ink pack 1 in the present embodiment is to further suppress leakage of a liquid.

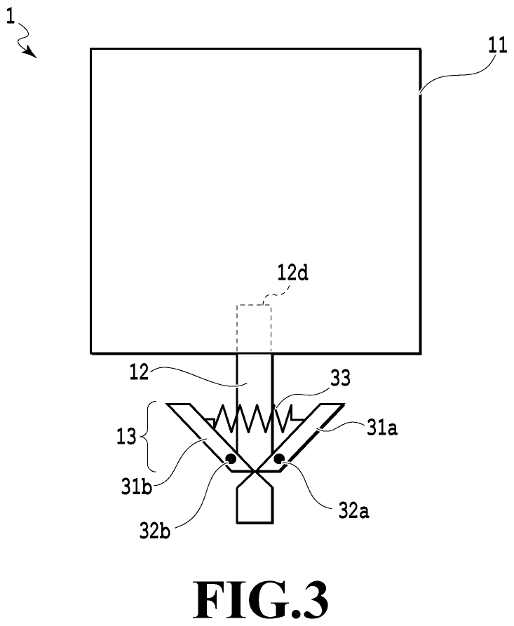

FIG. 3 is a schematic diagram of the ink pack 1 in the present embodiment.

As shown in FIG. 3, a flow passage holding portion 13 of the present embodiment includes a first pressing member 31a and a second pressing member 31b which press the flow passage portion 12 with each other. The flow passage holding portion 13 includes: a first turning shaft 32a configured to pivotally support the first pressing member 31a; and a second turning shaft 32b configured to pivotally support the second pressing member 31b. The flow passage holding portion 13 includes a compression spring 33 (biasing member) configured to bias the first pressing member 31a and the second pressing member 31b.

A base end portion of the first pressing member 31a and a base end portion of the second pressing member 31b are biased by the compression spring 33, so that inner surfaces of flow passage portion 12 are brought into close contact with each other in the state where the flow passage portion 12 is sandwiched between a front end portion of the first pressing member 31a and a front end portion of the second pressing member 31b. In this way, the flow passage portion 12 is closed.

In addition, by turning the first pressing member 31a about the first turning shaft 32a and turning the second pressing member 31b about the second turning shaft 32b while compressing the compression spring 33, the inner surfaces of the flow passage portion 12 are separated away from each other, so that the flow passage portion 12 is opened.

An example of the material for forming each of the first pressing member 31a, the second pressing member 31b, the first turning shaft 32a, the second turning shaft 32b, and the compression spring 33 includes a metal or a hard plastic, or the like.

Each of the first pressing member 31a, the second pressing member 31b, the first turning shaft 32a, the second turning shaft 32b, and the compression spring 33 can be detached from the flow passage portion 12. According to this configuration, each of the first pressing member 31a, the second pressing member 31b, the first turning shaft 32a, the second turning shaft 32b, and the compression spring 33 can be detached from the used ink pack 1, and reused.

Note that in the example of FIG. 3, one flow passage holding portion 13 is attached to the flow passage portion 12. However, a plurality of flow passage holding portions 13 may be attached to the flow passage portion 12. According to this configuration, since there are a plurality of portions where the flow passage portion 12 is closed, the possibility that the ink is leaked can be more reduced.

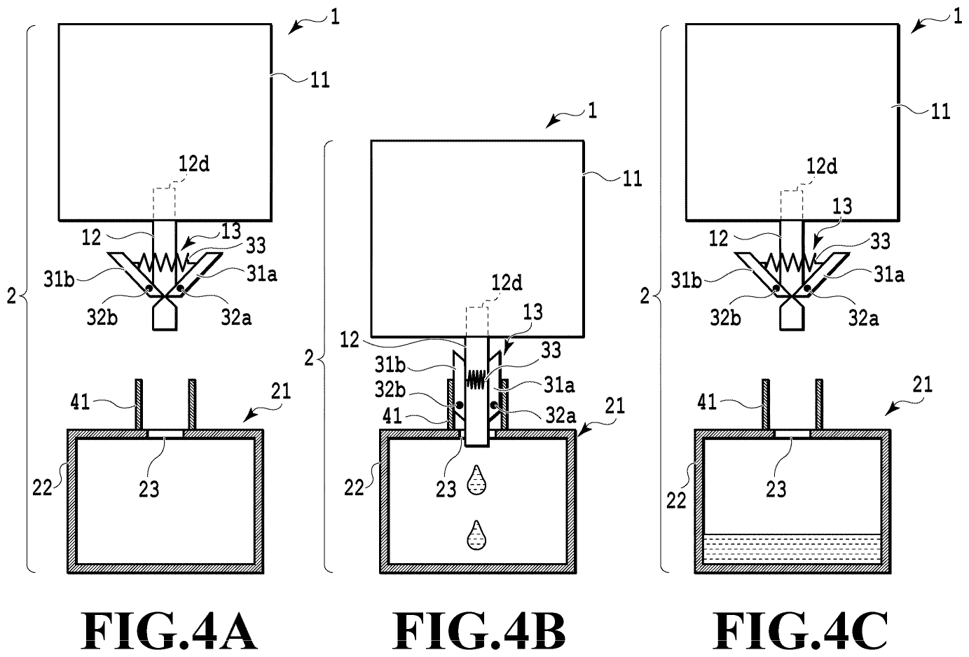

FIG. 4A to FIG. 4C are diagrams showing an ink replenishment method in the present embodiment.

As shown in FIG. 4A, a connection port 41 for connecting the flow passage holding portion 13 of the ink pack 1 is formed around the opening portion 23 in the ink tank 21 of the present embodiment. The inner diameter of the connection port 41 is larger than the outer diameter of the opening portion 23. Then, the inner diameter of the connection port 41 is smaller than the width of the flow passage holding portion 13 (the length in the left-right direction in FIG. 4A) in the state where the compression spring 33 is extended. Moreover, the inner diameter of the connection port 41 is larger than the width of the flow passage holding portion 13 (the length in the left-right direction in FIG. 4A) in the state where the compression spring 33 is compressed.

According to this configuration, in the case of inserting the flow passage portion 12 of the ink pack 1 into the opening portion 23 of the ink tank 21, the first pressing member 31a and the second pressing member 31b come into contact with edges of the connection port 41.

As shown in FIG. 4B, in the case of inserting the flow passage portion 12 into the opening portion 23 in the state where the first pressing member 31a and the second pressing member 31b have been in contact with the edges of the connection port 41, the first turning shaft 32a and the second turning shaft 32b are moved into the inside of the connection port 41. The ink pack 1 is brought close to the ink tank 21 in the state where the first pressing member 31a and the second pressing member 31b have been in contact with the edges of the connection port 41 and the first turning shaft 32a and the second turning shaft 32b have been located inside the connection port 41.

Then, the first pressing member 31a and the second pressing member 31b are pressed by the edges of the connection port 41, and the first pressing member 31a and the second pressing member 31b turn in directions of opening the flow passage portion 12. In the example of FIG. 4B, the first pressing member 31a turns counterclockwise about the first turning shaft 32a while compressing the compression spring 33, and the second pressing member 31b turns clockwise about the second turning shaft 32b while compressing the compression spring 33. In this way, the close contact between the inner surfaces of the flow passage portion 12 is released. That is, the flow passage portion 12 is brought into an open state. In this way, the replenishment of the ink tank 21 with the ink from the ink pack 1 is started.

In the state where the flow passage portion 12 has been opened, bringing the ink pack 1 closer to the ink tank 21 connects the flow passage portion 12 to the opening portion 23.

The periphery of the opening portion 23 of the present embodiment is covered with the connection port 41. In this way, the scattering of the ink to the outside of the ink tank 21 during the replenishment of the ink is suppressed.

As shown in FIG. 4C, after the replenishment of the ink ends, moving the ink pack 1 away from the ink tank 21 brings the flow passage holding portion 13 and the connection port 41 into the state where the flow passage holding portion 13 and the connection port 41 do not come into contact with each other. In this way, the compression spring 33 returns to the original shape with an elastic restoring force. That is, the compression spring 33 returns to the extended state. In this way, the flow passage portion 12 again returns to the state of being closed by the flow passage holding portion 13.

As described above, the flow passage portion 12 of the present embodiment is sandwiched to be closed by the first pressing member 31a and the second pressing member 31b. Hence, according to this configuration, the flow passage portion 12 can be more firmly closed than the configuration in which the flow passage portion 12 is bent to be closed.

Therefore, according to the ink pack 1 in the present embodiment, the leakage of a liquid can be further suppressed.

### Third Embodiment

In the following description, the same or corresponding configurations as or to those of the ink packs 1 in the above-mentioned embodiments will be denoted by the same signs and the description thereof will be omitted, and different points will be mainly described.

An object of an ink pack 1 in the present embodiment is to further suppress the leakage of a liquid.

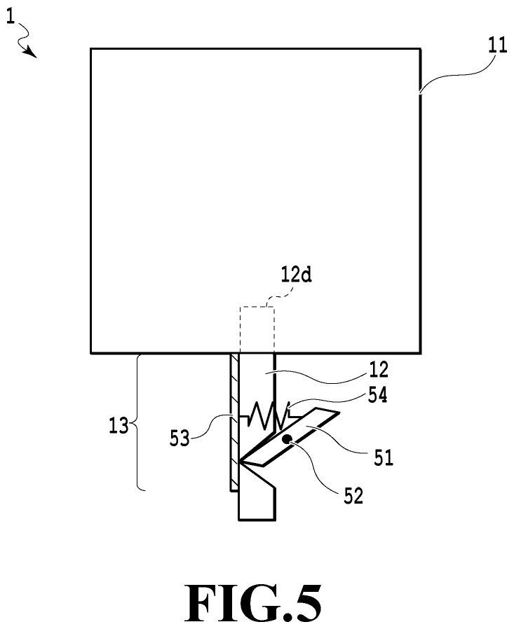

FIG. 5 is a schematic diagram of the ink pack 1 in the present embodiment.

As shown in FIG. 5, a flow passage holding portion 13 of the present embodiment includes: a pressing member 51 configured to press the flow passage portion 12; a turning shaft 52 configured to pivotally support the pressing member 51; and a supporting portion 53 configured to support the flow passage portion 12. Moreover, the flow passage holding portion 13 of the present embodiment includes a compression spring 54 (biasing member) fixed to the supporting portion 53 and configured to bias the pressing member 51.

A base end portion of the pressing member 51 is biased by the compression spring 54, the flow passage portion 12 is sandwiched between a front end portion of the supporting portion 53 and a front end portion of the pressing member 51, and inner surfaces of the flow passage portion 12 are brought into close contact with each other, so that the flow passage portion 12 of the present embodiment is closed.

In the example of FIG. 5, the pressing member 51 is pressed upward from below, so that the pressing member 51 turns counterclockwise about the turning shaft 52 while compressing the compression spring 54. In this way, the flow passage portion 12 of the present embodiment is opened.

An example of the material for forming each of the pressing member 51, the turning shaft 52, and the compression spring 54 includes a metal or a hard plastic, or the like. An example of the material for forming the supporting portion 53 includes hard rubber or the like. Each of the pressing member 51, the turning shaft 52, and the compression spring 54 can be detached from the flow passage portion 12. According to this configuration, each of the pressing member 51, the turning shaft 52, and the compression spring 54 can be detached from the used ink pack 1, and reused.

Moreover, the supporting portion 53 may be configured to be detachable from the containing portion 11 and the flow passage portion 12. According to this configuration, the supporting portion 53 can be detached from the used ink pack 1, and reused.

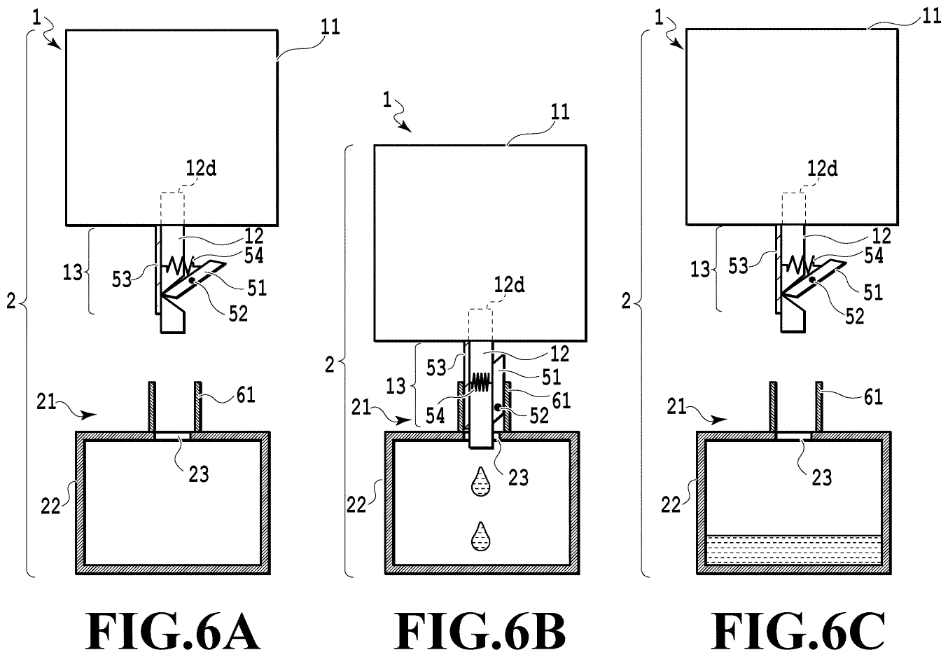

FIG. 6A to FIG. 6C are diagrams showing an ink replenishment method in the present embodiment.

As shown in FIG. 6A, a connection port 61 for connecting the flow passage holding portion 13 of the ink pack 1 is formed around the opening portion 23 in the ink tank 21 of the present embodiment. The inner diameter of the connection port 61 is larger than the outer diameter of the opening portion 23. Then, the inner diameter of the connection port 61 is smaller than the width of the flow passage holding portion 13 (the length in the left-right direction in FIG. 6A) in the state where the compression spring 54 is extended. Moreover, the inner diameter of the connection port 61 is larger than the width of the flow passage holding portion 13 (the length in the left-right direction in FIG. 6A) in the state where the compression spring 54 is compressed.

According to this configuration, in the case of inserting the flow passage portion 12 of the ink pack 1 into the opening portion 23 of the ink tank 21, the pressing member 51 comes into contact with an edge of the connection port 61.

As shown in FIG. 6B, in the case of inserting the flow passage portion 12 into the opening portion 23 in the state where the pressing member 51 has been brought in contact with the edge of the connection port 61, the turning shaft 52 and the supporting portion 53 are moved into the inside of the connection port 61. The ink pack 1 is brought closer to the ink tank 21 in the state where the pressing member 51 has been brought in contact with the edge of the connection port 61, and the turning shaft 52 and the supporting portion 53 have been located inside the connection port 61.

Then, the pressing member 51 is pressed by the edge of the connection port 61 to turn in the direction of opening the flow passage portion 12. In the example of FIG. 6B, the pressing member 51 turns counterclockwise about the turning shaft 52 while compressing the compression spring 54. In this way, the flow passage portion 12 is opened, and the replenishment of the ink is started.

The periphery of the opening portion 23 of the present embodiment is covered with the connection port 61. In this way, the scattering of the ink to the outside of the ink tank 21 during the replenishment of the ink is suppressed.

As shown in FIG. 6C, after the replenishment of the ink ends, moving the ink pack 1 away from the ink tank 21 brings the flow passage holding portion 13 and the connection port 61 into the state where the flow passage holding portion 13 and the connection port 61 do not come into contact with each other. In this way, the compression spring 54 returns to the extended state with an elastic restoring force. In this way, the flow passage portion 12 again returns to the state of being closed by the flow passage holding portion 13.

As described above, the flow passage portion 12 of the present embodiment is sandwiched to be closed by the pressing member 51 and the supporting portion 53. Hence, according to this configuration, the flow passage portion 12 can be more firmly closed than the configuration in which the flow passage portion 12 is bent to be closed.

Therefore, according to the ink pack 1 in the present embodiment, the leakage of a liquid can be further suppressed.

### Fourth Embodiment

In the following description, the same or corresponding configurations as or to those of the ink packs 1 in the above-mentioned embodiments will be denoted by the same signs and the description thereof will be omitted, and different points will be mainly described.

An object of an ink pack 1 in the present embodiment is to further suppress the leakage of a liquid.

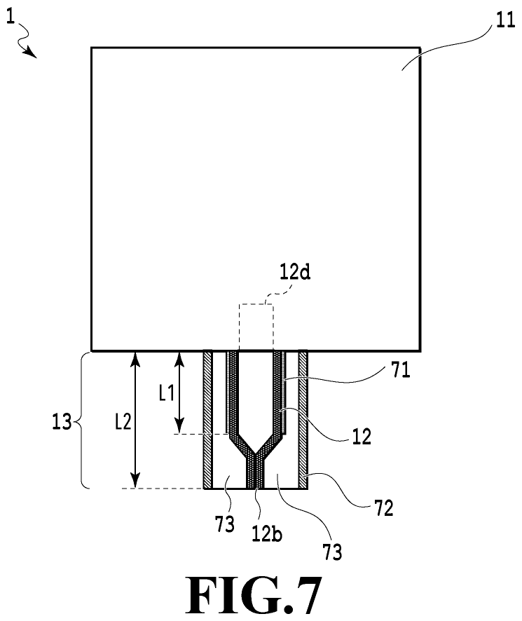

FIG. 7 is a schematic diagram of the ink pack 1 in the present embodiment.

As shown in FIG. 7, a flow passage holding portion 13 of the present embodiment includes a first cover portion 71 configured to cover a base end portion of an outer peripheral surface of the flow passage portion 12. The first cover portion 71 extends along a direction in which the flow passage portion 12 extends from the containing portion 11. In FIG. 7, the length by which the first cover portion 71 extends is represented by “L1”.

Around the first cover portion 71, a cylindrical second cover portion 72 configured to cover an outer peripheral surface of the first cover portion 71 and a front end portion of the flow passage portion 12 is provided. The second cover portion 72 extends along the direction in which the flow passage portion 12 extends from the containing portion 11. In FIG. 7, the length by which the second cover portion 72 extends is represented by “L2”. The length (L2) by which the second cover portion 72 extends is longer than the length (L1) by which the first cover portion 71 extends.

Between the first cover portion 71 and the second cover portion 72, a pressing member 73 containing a gas inside and being configured to press the front end portion of the flow passage portion 12 is provided. The Shore A hardness of the pressing member 73 is 30 or less. An example of the material of the pressing member 73 includes silicone or urethane, or the like.

At a front end portion 12b of the flow passage portion 12, inner surfaces of the flow passage portion 12 are brought into close contact with each other by an internal pressure of the pressing member 73, so that the outlet of the flow passage portion 12 is closed.

In the ink pack 1 of the present embodiment, the ink is pushed out from the containing portion 11 by the user pressing the containing portion 11, and the front end portion 12b of the flow passage portion 12 is pushed and expanded by a water pressure of the ink. By the pushing and expanding of the front end portion 12b of the flow passage portion 12, the pressing member 73 is pushed back and deformed. In this way, in the ink pack 1 of the present embodiment, the flow passage portion 12 is opened by the deformations of the flow passage portion 12 and the pressing member 73.

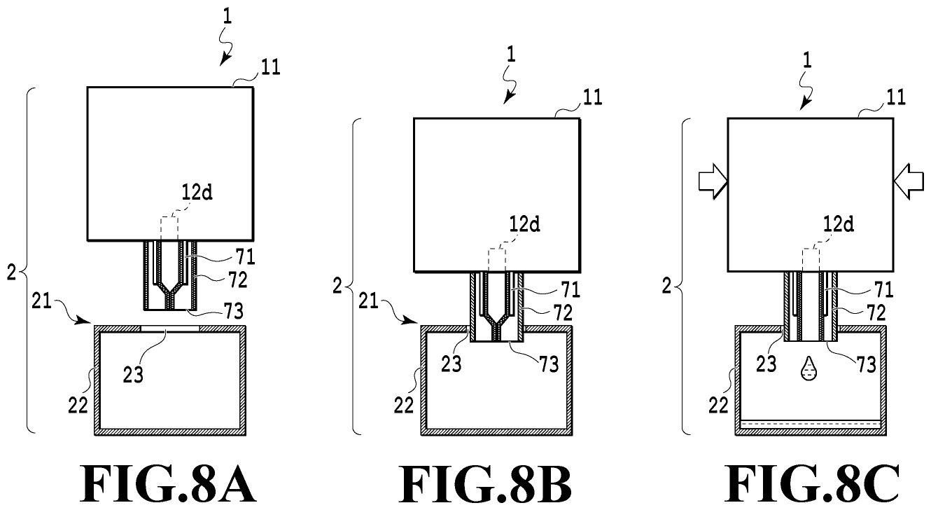

FIG. 8A to FIG. 8C are diagrams showing an ink replenishment method in the present embodiment.

As shown in FIG. 8A, an opening portion 23 is formed in a main body 22 of an ink tank 21. The inner diameter of the opening portion 23 of the ink tank 21 of the present embodiment is larger than the outer diameter of the second cover portion 72 of the ink pack 1.

As shown in FIG. 8B, in the case of replenishing the ink tank 21 of the present embodiment with the ink, the second cover portion 72 is first inserted into the opening portion 23.

As shown in FIG. 8C, in the state where the second cover portion 72 has been inserted into the opening portion 23, a pressure value inside the containing portion 11 is increased. For example, the pressure value inside the containing portion 11 can be increased by pressing the containing portion 11 with a hand as compared with the state where the containing portion 11 is not pressed.

By increasing the pressure value inside the containing portion 11, a pressure value inside the flow passage portion 12 which communicates with the containing portion 11 is also increased. The increase in pressure value inside the flow passage portion 12 pushes and expands the front end portion of the flow passage portion 12 from the inside toward the outside, so that the state where the inner surfaces of the flow passage portion 12 are in close contact with each other is released. That is, the flow passage portion 12 is opened by the pressing of the containing portion 11. Then, the ink tank 21 is replenished with the ink from the ink pack 1.

After the replenishment of the ink, the pressing of the containing portion 11 may be stopped. By stopping the pressing of the containing portion 11, the pressure value inside the containing portion 11 is reduced. In this way, the inner surfaces of the flow passage portion 12 are again brought into close contact with each other by the internal pressure of the pressing member 73. That is, the flow passage portion 12 returns to the closed state.

In this way, in the ink pack 1 of the present embodiment, the replenishment of a liquid can be achieved by repeating the pressing of the containing portion 11 and the stopping of the pressing. According to this configuration, the flow passage portion 12 can be more firmly closed than the configuration in which the flow passage portion 12 is bent to be closed.

Therefore, according to the ink pack 1 in the present embodiment, the leakage of a liquid can be further suppressed.

### Fifth Embodiment

In the following description, the same or corresponding configurations as or to those of the ink packs 1 in the above-mentioned embodiments will be denoted by the same signs and the description thereof will be omitted, and different points will be mainly described.

An object of an ink pack 1 in the present embodiment is to further suppress the leakage of a liquid.

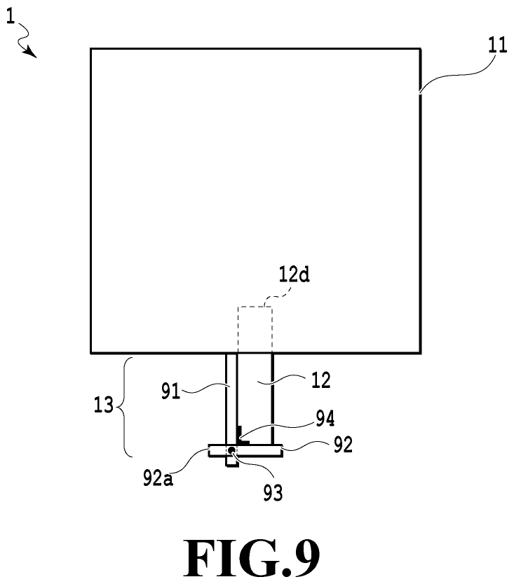

FIG. 9 is a schematic diagram of the ink pack 1 in the present embodiment.

As shown in FIG. 9, a flow passage holding portion 13 of the present embodiment includes: a fixing member 91 provided on an outer side of the flow passage portion 12; a lid member 92 configured to close the outlet of the flow passage portion 12; and a turning shaft 93 provided in a front end portion of the fixing member 91 and configured to pivotally support the lid member 92. At an intersection portion where the fixing member 91 and the lid member 92 intersect, a plate spring 94 (biasing member) is attached.

The lid member 92 moves from an initial position to close the flow passage portion 12 to a position to open the flow passage portion 12 with an external force applied thereto, and returns from the initial position to open the flow passage portion 12 to the position to close the flow passage portion 12 with an elastic restoring force of the plate spring 94.

Specifically, in the state where an external force is not applied to the lid member 92, the lid member 92 is biased by the plate spring 94 to be located at the initial position to close the outlet of the flow passage portion 12. In the example of FIG. 9, by pressing a base end portion 92a of the lid member 92 upward from below, the lid member 92 turns clockwise about the turning shaft 93 by 90 degrees. By this turning, the flow passage portion 12 is opened. Then, once the state where the base end portion 92a has been pressed is released, the lid member 92 turns counterclockwise about the turning shaft 93 by 90 degrees to return to the initial position with an elastic restoring force of the plate spring 94.

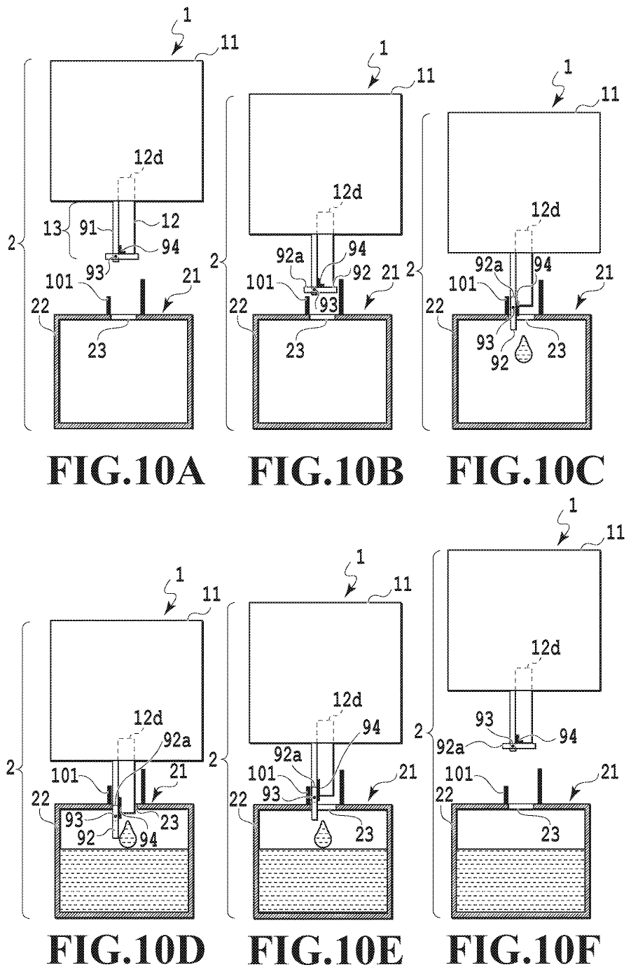

FIG. 10A to FIG. 10F are diagrams showing an ink replenishment method in the present embodiment.

As shown in FIG. 10A, a connection port 101 for connecting the flow passage holding portion 13 of the ink pack 1 is formed around the opening portion 23 in the ink tank 21 of the present embodiment. The inner diameter of the opening portion 23 is slightly larger than a length obtained by adding the width of the fixing member 91 (the length in the left-right direction in FIG. 10A) and the width of the flow passage portion 12 (the length in the left-right direction in FIG. 10A). The inner diameter of the connection port 101 is slightly larger than the outer diameter of the opening portion 23.

As shown in FIG. 10B, in the case of inserting the flow passage portion 12 into the opening portion 23, the base end portion 92a of the lid member 92 comes into contact with an edge of the connection port 101.

As shown in FIG. 10C, in the state where the base end portion 92a of the lid member 92 has been brought into contact with the edge of the connection port 101, the ink pack 1 is brought closer to the ink tank 21. Then, the lid member 92 turns about the turning shaft 93 in the direction of opening the flow passage portion 12 while extending the plate spring 94. In the example of FIG. 10C, the lid member 92 turns clockwise. In this way, the flow passage portion 12 is opened, so that the replenishment of the ink is started.

As shown in FIG. 10D, during the replenishment of the ink, the base end portion 92a is in contact with an inner surface of the connection port 101 or an inner surface of the opening portion 23. According to this configuration, even if the lid member 92 attempts to return to the initial position with the elastic restoring force of the plate spring 94, the base end portion 92a hits the inner surface of the connection port 101 or the inner surface of the opening portion 23. Hence, the lid member 92 is not closed, and the state where the flow passage portion 12 has been opened is maintained.

In addition, the connection port 101 of the present embodiment covers the periphery of the opening portion 23. In this way, the scattering of the ink to the outside of the ink tank 21 during the replenishment of the ink is suppressed.

As shown in FIG. 10E, after the replenishment of the ink, the ink pack 1 is moved away from the ink tank 21.

As shown in FIG. 10F, once the state where the base end portion 92a of the lid member 92 is not in contact with the edge of the connection port 101 is established, the lid member 92 returns to the initial position with the elastic restoring force of the plate spring 94. That is, the flow passage portion 12 is again closed by the lid member 92.

According to this configuration, the flow passage portion 12 can be more firmly closed than the configuration in which the flow passage portion 12 is bent to be closed.

Therefore, according to the ink pack 1 in the present embodiment, the leakage of a liquid can be further suppressed.

### Other Embodiments

In the above-mentioned examples, the description has been made on the assumption that the containing portion 11 has flexibility. However, the containing portion 11 does not have to have flexibility. For example, the containing portion 11 may be made of a hard plastic. That is, the technology of the present disclosure can be used in the case of replenishing the ink tank 21 with an ink contained in a so-called ink bottle as well.

In the above-mentioned examples, the ink is used as a liquid; however, the liquid that can be used in the technology of the present disclosure is not limited to an ink. It is possible to use various liquids including treatment liquids and the like used for the purpose of improving the fixing property of an ink to a printing medium (for example, paper), reducing the gloss unevenness, improving the scratch resistance, and the like.

According to the liquid container of the present disclosure, the configuration of opening and closing a flow passage portion can be further simplified.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-054448, filed Mar. 27, 2025, which is hereby incorporated by reference herein in its entirety.

What is claimed is:

1. A liquid container comprising:
a containing portion configured to contain an ink; and
a flow passage portion provided to the containing portion and configured to supply the ink from inside the containing portion to outside, wherein
the flow passage portion has flexibility, and is closed by being deformed.

2. The liquid container according to claim 1, wherein
inner surfaces of the flow passage portion are brought into close contact with each other by bending the flow passage portion.

3. The liquid container according to claim 1, wherein
Shore A hardness of the flow passage portion is 30 or less.

4. The liquid container according to claim 3, wherein
a material of the flow passage portion is silicone or urethane.

5. The liquid container according to claim 1, further comprising:
a flow passage holding portion provided on an outer side of the flow passage portion and configured to hold the flow passage portion, wherein
in a state where a front end portion of the flow passage portion is held by the flow passage holding portion, the flow passage portion is in a closed state, and
in a state where the front end portion of the flow passage portion is removed from the flow passage holding portion, the flow passage portion is in an open state.

6. The liquid container according to claim 5, wherein
the flow passage holding portion is detachable from the flow passage portion.

7. The liquid container according to claim 1, further comprising:
a flow passage holding portion provided on an outer side of the flow passage portion and configured to hold the flow passage portion, wherein
the flow passage holding portion includes:
a first pressing member configured to press the flow passage portion;
a second pressing member configured to press the flow passage portion; and
a biasing member configured to bias the first pressing member and the second pressing member,
in a state where the biasing member is extended, the flow passage portion is sandwiched between the first pressing member and the second pressing member, so that the flow passage portion is closed, and
in a state where the biasing member is compressed, the flow passage portion is opened.

8. The liquid container according to claim 7, wherein
the flow passage holding portion is detachable from the flow passage portion.

9. The liquid container according to claim 1, further comprising:
a flow passage holding portion provided on an outer side of the flow passage portion and configured to close the flow passage portion, wherein
the flow passage holding portion includes:
a pressing member configured to press the flow passage portion;
a supporting portion configured to support the flow passage portion; and
a biasing member fixed to the supporting portion and configured to bias the pressing member,
in a state where the biasing member is extended, the flow passage portion is sandwiched between the pressing member and the supporting portion, so that the flow passage portion is closed, and
in a state where the biasing member is compressed, the flow passage portion is opened.

10. The liquid container according to claim 9, wherein
the flow passage holding portion is detachable from the flow passage portion.

11. The liquid container according to claim 1, further comprising:
a flow passage holding portion provided on an outer side of the flow passage portion and configured to close the flow passage portion, wherein
the flow passage holding portion includes:
a pressing member configured to press the flow passage portion to close the flow passage portion,
a gas is contained inside the pressing member,
in a case where the containing portion is pressed, the ink is pushed out from the containing portion,
the ink pushed out from the containing portion pushes back the pressing member, so that the flow passage portion is opened.

12. The liquid container according to claim 11, wherein
Shore A hardness of the pressing member is 30 or less.

13. The liquid container according to claim 12, wherein
a material of the pressing member contains silicone or urethane.

14. A liquid replenishment system comprising:
a liquid container including a containing portion configured to contain an ink, and a flow passage portion provided to the containing portion and configured to supply the ink from inside the containing portion to outside; and
a tank configured to store the ink, wherein
the flow passage portion has flexibility, and is closed by being deformed,
the liquid container further includes a flow passage holding portion provided on an outer side of the flow passage portion and configured to hold the flow passage portion,
in a state where a front end portion of the flow passage portion is held by the flow passage holding portion, the flow passage portion is in a closed state,
in a state where the front end portion of the flow passage portion is removed from the flow passage holding portion, the flow passage portion is in an open state,
in the tank, an opening portion having an inner diameter smaller than a width of the flow passage holding portion and larger than an outer diameter of the flow passage portion is formed, and
in a state where part of the flow passage portion is inserted into the opening portion, the flow passage holding portion comes into contact with an edge of the opening portion, and the front end portion of the flow passage portion is removed from the flow passage holding portion, allowing the tank to be replenished with the ink from the liquid container.
